(19) United States
(12) Patent Application Publication
(10) Pub. No.: US 2010/0238452 A1
(43) Pub. Date: Sep. 23, 2010

(54) Dual Fiber Stretchers for Dispersion Compensation

(76) Inventors: Frederique Vanholsbeeck, Auckland (NZ); Stephane Coen, Auckland (NZ); Sairam Iyer, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/637,910

(22) Filed: Dec. 15, 2009

Related U.S. Application Data
(60) Provisional application No. 61/122,513, filed on Dec. 15, 2008.

(51) Int. Cl. G01B 9/02; G02B 26/00; H04J 14/02

(52) U.S. Cl. 356/477; 385/1; 398/82

(57) ABSTRACT

An optical system having at least two waveguides that are deformable to provide adjustments to dispersion and path length.

### REFERENCE TO PRIOR APPLICATION

This application claims the benefit of U.S. Provisional Application No. 61/122,513, filed Dec. 15, 2008 the entirety of which is incorporated herein by reference.

### FIELD OF THE INVENTION

The present invention broadly relates to optical fiber based dispersion compensation and in particular to an all fiber based dispersion compensation system used for Optical Coherence Tomography.

### BACKGROUND TO THE INVENTION

Fiber optic systems having light propagating in multiple parallel paths, such as interferometers and Wavelength Division Multiplexed (WDM) systems, often suffer from output distortion due to dispersion mismatch between paths. Dispersion mismatch arises from differences between optical paths such as refractive index, optical fiber manufacturing tolerance and the use of different components.

One example of a dispersion sensitive interferometer based device is an Optical Coherence Tomography (OCT) system. An OCT system produces three dimensional images of biological tissues. Dispersion imbalance in an OCT device reduces system resolution due to distortion of the point-spread-function.

Similarly, optical systems employing WDM signals often suffer dispersion mismatch between co-propagating wavelengths in an optical fiber. Dispersion mismatch between WDM signals in an optical fiber distorts the signal due to optical pulses travelling at different speeds in a fiber.

One solution of the prior art for compensating interferometer arm dispersion imbalance in fiber optic systems is to use a common-path interferometer where an autocorrelator matches interferometer path lengths. However, when the autocorrelator solution is embodied in a fiber it introduces further disadvantageous fiber-induced dispersion imbalance. Dispersion can partially be compensated by matching fiber lengths with sub-mm accuracy, but this is difficult to achieve in practice. Another problem with such systems is that the manufacturing tolerance of fibers, typically within 1%, causes dispersion imbalance even when fiber lengths are identical.

### SUMMARY OF THE INVENTION

It is therefore an object of the present invention to provide a system or method for compensating for dispersion mismatch, or at least provide the public with a useful choice.

In a first broad aspect the invention consists in an optical system, comprising:

an input adapted to couple light to at least two optical paths, a first optical path having a first waveguide, the first waveguide having a first dispersion parameter, a first optical path length and is deformable to change the first dispersion parameter and the first optical path length,

the second optical path having a second waveguide, the second waveguide having a second dispersion parameter, a second optical path length and is deformable to change the second dispersion parameter and the second optical path length,

an output adapted to receive light from the at least two optical paths

a first deforming device adapted to deform the first waveguide, and

a second deforming device adapted to deform the second waveguide,

wherein the first deforming device and the second deforming device are operable to adjust the dispersion of light in the first optical path and maintain the path length of the first optical path relative to the second optical path.

Preferably the first optical path is a first arm of a Mach-Zehnder interferometer and the second optical path is a second arm of the Mach-Zehnder interferometer.

Preferably the first arm has an interferometry output for coupling light from the first arm and an interferometry input for coupling light into the first arm.

Preferably the light coupled out of the first arm by the interferometry output is reflected by a sample under test and coupled into the first arm by the interferometry input.

Preferably the system is an Optical Coherence Tomography apparatus, the apparatus further comprising:

a broadband light source adapted to transmit to the input,

a detector adapted to receive light from the output, and

a delay line located in either the first or the second optical path.

Preferably the system is Wavelength Division Multiplexing apparatus.

Preferably the first waveguide and the second waveguide have unequal dispersion parameters.

Preferably the dispersion parameter is a second order dispersion coefficient.

Preferably at least the first waveguide or the second waveguide is an optical fiber.

Preferably at least the first deforming device or the second deforming device is an optical fiber stretcher.

Preferably the first waveguide has a first waveguide dispersion modifier coefficient, the second waveguide has a second waveguide dispersion modifier coefficient, and a ratio between the first and second dispersion parameters, multiplied by their respective strain induced waveguide dispersion modifier coefficients, are unequal.

In another broad aspect the invention is said to consist in a method of arranging an optical system, comprising the steps of:

adapting an light receiver to receive light from a light source and couple the input light to at least two optical paths,

arranging a first deformable waveguide in a first optical path, the first waveguide having a first dispersion parameter and a first optical path length, the first waveguide deformable to alter the first dispersion parameter and the first optical path length,

arranging a second deformable waveguide in a second optical path, the second waveguide having a second dispersion parameter and a second optical path length, the second waveguide deformable to alter the second dispersion parameter and the second optical path length,

deforming the first and the second waveguides adjust the first and second dispersion parameters and maintain the path length of the first optical path relative to the second optical path.

Preferably the method further comprises configuring the first optical path is to be a first arm of a Mach-Zehnder interferometer and configuring the second optical path to be a second arm of the Mach-Zehnder interferometer.

Preferably the method further comprises configuring an interferometry output in the first arm has for coupling light from the first interferometer arm and an interferometry input for coupling light into the first interferometer arm.

Preferably the method further comprises transmitting light from the interferometry output to a sample under test, and receiving light reflected from the sample in the interferometry input.

Preferably at least the first deforming device or the second deforming device is an optical fiber stretcher.

In another broad aspect the invention is said to consist in an optical system, comprising:

an optical path having at least at first and second waveguide,

a first waveguide having an input to receive light and an output to transmit light,

a second waveguide having an input to receive light and an output to transmit light, the input of the second waveguide configurable to receive light from the input of the first waveguide,

a first deforming device adapted to deform the first waveguide, and

a second deforming device adapted to deform the second waveguide,

wherein the first deforming device and the second deforming device are operable to adjust the dispersion of light in the optical path and the optical path length.

Preferably the system is Wavelength Division Multiplexing apparatus.

Preferably the first waveguide and the second waveguide have unequal dispersion parameters.

Preferably the dispersion parameter is a second order dispersion coefficient.

Preferably at least the first waveguide or the second waveguide is an optical fiber.

Preferably at least the first deforming device or the second deforming device is an optical fiber stretcher.

Preferably the first waveguide has a first waveguide dispersion modifier coefficient, the second waveguide has a second waveguide dispersion modifier coefficient, and a ratio between the first and second dispersion parameters, multiplied by a respective strain induced waveguide dispersion modifier coefficients, are unequal.

In another broad aspect the invention is said to consist in a method of arranging an optical system, comprising:

arranging at least a first and second waveguide in series to define an optical path, the first waveguide having an input to receive light and an output to transmit light, the second waveguide having an input to receive light and an output to transmit light.

Preferably the method further comprises deforming the first and the second waveguides to adjust the dispersion of the light in the optical path.

Preferably method further comprises transmitting a broadband light source to the input of the optical path.

The invention consists in the foregoing and also envisages instructions of which the following gives examples.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term ‘comprising’ as used in this specification means ‘consisting at least in part of’, that is to say when interpreting statements in this specification which include that term, the features, prefaced by that term in each statement, all need to be present but other features can also be present.

### BRIEF DESCRIPTION OF THE DRAWINGS

Preferred forms of the present invention will now be described with reference to the accompanying drawings in which:

FIG. 1 illustrates an example of an all fiber optical system incorporating fiber stretching devices to compensate dispersion and maintain group delay.

FIGS. 2a -e illustrate point spread functions of an image output from an all-fiber optical coherence tomography system.

FIG. 3 illustrates an example of the all fiber optical system of FIG. 1 where two fiber stretching devices are located in one interferometer arm.

FIG. 4 illustrates an example of a WDM system having two fiber stretching devices used to compensate dispersion.

FIG. 5 illustrates an optical system with multiple dispersion compensated paths.

### DETAILED DESCRIPTION OF PREFERRED EMBODIMENTS

Optical Coherence Tomography (OCT) is a real-time non-invasive optical imaging technique that can produce high resolution images of biological tissues. The technique is based on low coherence white light interferometry where image slices within the depth of a sample placed in one interferometer arm are obtained by scanning an optical time delay line in the reference arm of the interferometer.

OCT systems have been implemented in many different interferometer arrangements. Of particular interest is the use of optical fibers and broadband fiber couplers to construct an OCT interferometer. Fiber-based OCT systems present several advantages in terms of compactness, flexibility, and easiness of light distribution to the sample, especially for use in in vivo experiments.

However, most known fiber-based OCT systems still rely on some optical free-space components to match path lengths, such as an optical delay line. Further, the use of optical fibers has an inherent chromatic dispersion mismatch problem between the two arms of the interferometer. A sample under test will also often introduce dispersion. Chromatic dispersion broadens the point-spread-function (PSF) of an OCT system and degrades the axial resolution of the output image. Further still, interferometry requires precision construction of the arms to ensure equal optical path lengths.

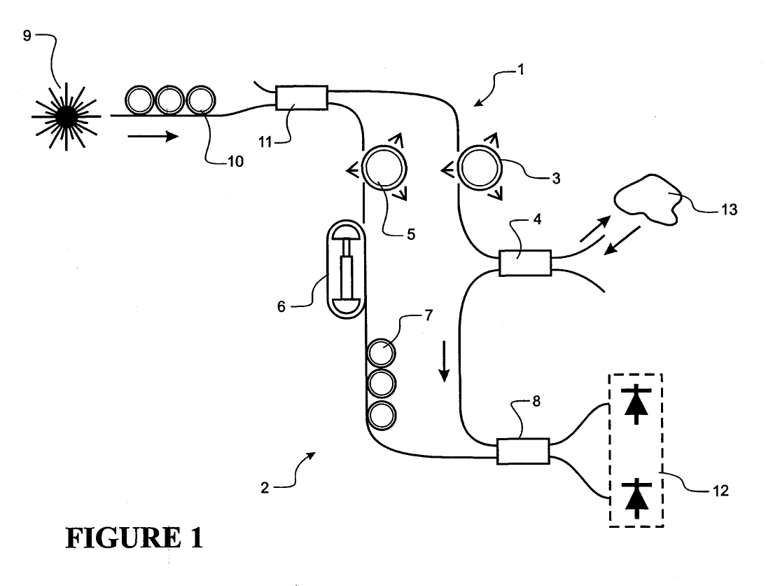

FIG. 1 shows an OCT system arranged from optical fiber based devices incorporating a preferred form of the present invention. The OCT system is based on a Mach-Zehnder interferometer generally shown to have a first arm, known as a sample arm 1, and a second arm, known as a reference arm 2. The sample arm 1 includes a first fiber stretching device 3 and a broadband optical coupler 4. The reference arm 2 includes a second fiber stretching device 5, a third fiber stretching device 6 and a polarisation controller 7. The sample arm 1 and the reference arm 2 are combined by a broadband optical coupler 8. Light coupled out of the interferometer by coupler 8 is detected by a balanced detector 12. A broadband light source 9 is coupled into each interferometer arm 1, 2 via a polarisation controller 10 and another broadband optical coupler 11.

During tomography measurements, light from light source 9 is coupled into each interferometer arm. Light is output from the sample arm 2 via coupler 4 and directed toward a sample to be tested 13. A portion of the light transmitted to the sample 13 is reflected and coupled back into the fiber setup and input to the reference arm 2 by coupler 4. The detector 12 measures the light emitted from the interferometer after light in the reference arm 1 and sample arm 2 has been recombined at the coupler 8. The polarisation controller 10 is adjustable to maximise the fringe contrast at the output.

Variable optical delay is required to scan the depth of the sample 13. The third fiber stretcher 6 shown in the reference arm of the interferometer provides the required variable optical delay. It is preferable that the variable delay device 6 is provided by an all fiber device such as a piezoelectric actuator fiber stretcher.

Operation of the first and second fiber stretchers will now be described. A fiber having length L and second order dispersion coefficient β₂ undergoes a change in dispersion upon elastic stretching. Lengthening the fiber by ΔL increases the fiber length-integrated dispersion ø₂=β₂L by Cβ₂ΔL, where C is a modifier coefficient that accounts for the strain-induced optical geometrical changes of the fiber that lead to a corresponding modification of the dispersion coefficient. Note that C is typically lower than 1 which means that the dispersion of a stretched fiber becomes lower than that of an unstretched fiber of the same length.

The preferred embodiment of the invention has different fiber types (A and B) with different dispersion coefficients (β₂^{A} and β₂^{B}) in each fiber stretcher 3, 5. However fibers with similar or the same dispersion coefficients could also be used although the effects are not as dramatic. Similarly, fibers with different C values could also be used to similar effect. If we stretch (or un-stretch) both fibers by the same extra length ΔL, the optical path length between the two arms of the interferometer is left unchanged, but, advantageously, the difference in integrated dispersion is modified by (C_{A}β₂^{A}-C_{B}β₂^{B}) ΔL. Note that equal group velocity is assumed here, although the system functions equally well when group velocities are not equal. Continuous stretching allows for a continuous change in relative dispersion between the two arms of the interferometer. Therefore dispersion arising at the output of the interferometer, caused by dispersion mismatch between the interferometer arms, is compensated for by the use of the described system without resorting to the use of non fiber based components. It is therefore evident that at least either C or β₂ must be different between each stretcher to provide dispersion compensation.

A theoretical explanation is as follows as applied to a Mach-Zehnder interferometer. A Mach-Zehnder interferometer presents an initial path length imbalance ΔL=L_{A}-L_{B} and dispersion imbalance ø₂=ø₂^{A}-ø₂^{B}. The amounts ΔL_{A} (Equation 3) and ΔL_{B} (Equation 4) by which one has to stretch the two arms of the interferometer to balance both the group delay (Equation 1) and the dispersion (Equations 2) are such that:

$$\begin{matrix}Δ L + Δ {L}_{A} = Δ {L}_{B} & ( 1 ) \\ {Δφ}_{2} + {C}_{A} {β}_{2}^{A} Δ {L}_{A} = {C}_{B} {β}_{2}^{B} Δ {L}_{B} & ( 2 ) \\ Δ {L}_{A} = - \frac{1}{κ - 1} \frac{{Δφ}_{2}}{{C}_{B} {β}_{2}^{B}} + \frac{1}{κ - 1} Δ L & ( 3 ) \\ Δ {L}_{B} = - \frac{1}{κ - 1} \frac{{Δφ}_{2}}{{C}_{B} {β}_{2}^{B}} + \frac{κ}{κ - 1} Δ L & ( 4 )\end{matrix}$$

Where κ=(C_{A}β₂^{A})/(C_{B}β₂^{B}) is essentially the ratio between the dispersion coefficients of the two fibers. In equations 3 and 4, the first term represents the amount of stretching needed to cancel the original dispersion imbalance while keeping the relative group delay constant (since these terms are the same for ΔL_{A} and ΔL_{B}) and the second term represents the amount of stretching required to vary the path difference by ΔL without changing the dispersion. It is advantageous to use fibers with dispersion coefficients as different as possible (i.e. κ not equal to 1, but rather much larger than 1, close to zero, or negative) to maximize the amount of dispersion that can be compensated within the elastic stretching limit of the fibers used. Typically, silica based fibers can be stretched up to 2% of their original length.

An absolute value of K much larger or much smaller than 1 leads to control of dispersion and optical delay independently between the two fiber stretchers. For example, when κ much larger than 1, most of the dispersion adjustment is obtained by stretching the highly dispersive fiber A by an amount much smaller than ΔL while stretching fiber B mainly tunes the relative optical delay.

The preferred fiber stretcher is made from a length of fiber wrapped around a rubber cylinder that is sandwiched between two plates. The plates are tightened together to squash the rubber and outwardly expand the cylinder and therefore the wrapped fiber. The length of wrapped fiber in a fiber stretcher used for experimental verification is approximately 4 m. However, any length of fiber may be used. Compressive forces on the rubber cylinder cause the outer diameter to grow and apply an even outward force that stretches the wrapped fiber. The tightening force may be applied manually, or under automated control. Automated control advantageously allows for dynamic stabilisation of dispersion matching and optical path length by way of a feedback signal from the interferometer output. This is particularly advantageous as dispersion will often depend on the scan depth of a sample under test.

To verify the system experimentally the fiber stretcher 3 located in the sample arm is constructed with FiberCore SM800 fiber. This fiber has a single mode cut-off wavelength of 730 nm and is therefore compatible with our broadband optical source (a 85 nm wide SLED source centered at 845 nm). This particular fiber used has a dispersion coefficient measured to be β₂^{A}2^{A=38} ps²/km at 845 nm by white-light interferometry. The fiber stretcher 5 located in the reference arm 2 is constructed with Crystal Fiber LMA-5 photonic crystal fiber (PCF). This fiber was chosen for having properties similar to that of the SM800 fiber in terms of its single-mode guidance, high transparency in our wavelength range, and similar core diameter (5 μm versus 5.6 μm for the SM800 fiber). This particular fiber has a significantly different dispersion parameter of β₂^{B}=23 ps²/km at 845 nm, again obtained by white-light interferometry. Note that either β₂^{A}, β₂^{B}, or both could be negative dispersion values if desired.

Note that the use of two different fiber types in the setup introduces a dispersion imbalance per se. The bulk of that imbalance is easily compensated by using appropriate lengths of both fiber types in each arm of the interferometer. An appropriate length can be coarsely cut since the fiber stretchers will fine tune fiber lengths over several cm with sub-mm accuracy.

For initial setting of the fiber length it is advantageous to be able to measure the relative delay between different wavelength components of the broadband optical source 9. The fiber length is then adjustable accordingly. Preferably the light source 9 comprises 3 multiplexed SLED sources with different center wavelengths that can be switched on independently.

For experimental verification, in the optical system used for OCT, the sample arm has a first 13 m section of SM800 fiber and 4.3 m of PCF fiber. The reference arm has 12.8 m of SM800 fiber and 4.7 m of PCF fiber. An air gap of 15 cm exists between the coupler 4 and the sample. However, this air gap could be considerably less.

Note that using two arms of identical length of the same fiber does not guarantee perfect dispersion balance. This was particularly striking during preliminary experiments entirely based on SM800 fibers where our depth resolution was as high as 400 μm instead of the expected 5.1 μm. The discrepancy is due to differences in the order of 1% or less in the dispersion of different batches of fiber as well as longitudinal fluctuations along the fiber lengths. Some discrepancy is expected for non-telecoms grade fibers where a manufacturing tolerance for fibers is typically 1%. The discrepancy clearly stresses the importance of an all-fiber dispersion compensator for fiber-based optical systems.

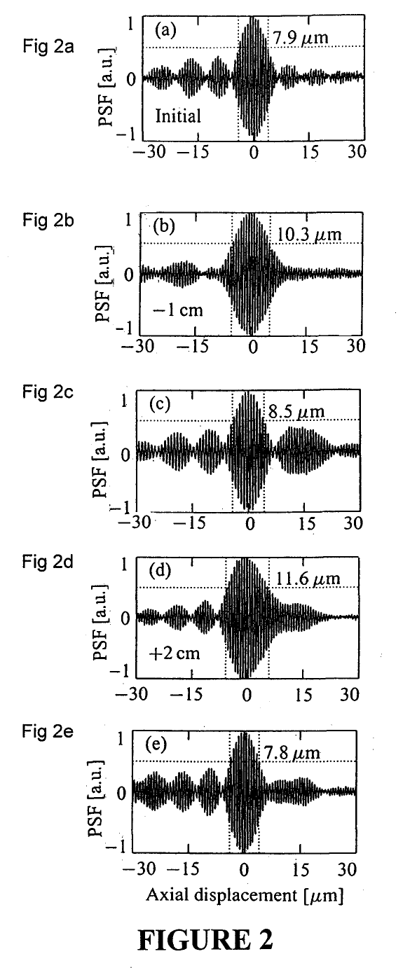

To test the response of the interferometer system a measurement of the point spread function (PSF) is made. The response of the system shown in FIG. 1 is made by replacing the sample 13 with a mirror (not shown). FIG. 2(a) shows the optimized PSF of our OCT system versus the axial depth in air. The full-width-at-half-maximum (FWHM) of the PSF is 5.6 μm and is therefore close to the theoretical expectation of 5.1 μm calculated by taking the Fourier transform of the source intensity spectrum of the light source used for acquiring experimental data.

Note that the light source has a non-Gaussian spectrum which partly explains the side lobes of the PSF. Side lobes are further encouraged by some third-order dispersion imbalance and some polarization effects due to the fibers not maintaining polarization of the input light.

During testing of the system the sample mirror (not shown) was first moved by a certain distance in the air portion of the sample arm. The extra optical delay is compensated by (un)stretching the fiber of the reference arm only, thereby artificially introducing some dispersion imbalance. Accordingly, the broadened PSF is observable as shown in FIGS. 2(b) and (d). FIGS. 2(b) and (d) correspond to a mirror displacement of 1 cm towards and 2 cm away from the fiber end, respectively.

The FWHM of the PSF indicated in FIG. 2(b) is 30% broader than the initial PSF shown in FIG. 2(a). Further, the FWHM of the PSF indicated in FIG. 2(d) is 46% broader than the initial PSF shown in FIG. 2(a). For these two cases, the dispersion imbalance has then been compensated by adjusting the two stretchers simultaneously while leaving the sample mirror fixed. FIGS. 2(c) and 2(e) show that the PSF can be recompressed close to its original width. Therefore the dispersion compensator of the present invention compensates for positive and negative amounts of dispersion corresponding to about 4 cm of air-equivalent fiber length.

Note that, in the current demonstration, our PCF introduces a third-order dispersion imbalance since it has a dispersion slope β₃=0.04 ps³/km which is approximately twice as large as that of the SM800 fiber. The additional amount of third-order dispersion introduced by stretching the fibers is negligible in comparison to the initial imbalance due to the difference in the β₃ coefficients of our two fiber types. Therefore, the stretchers only modify the second-order dispersion coefficient of the system and demonstrate that compensation of the full amount of artificially introduced second-order dispersion is achievable.

Any imbalance of third-order dispersion leading to unwanted ripples in the PSF may be resolved by using two fibers with different β₂ coefficients but identical β₃ coefficients. This is possible due to the great flexibility in designing a dispersion coefficient in PCF fiber design.

Therefore, by using two fiber stretchers made up of different fiber types an all-fiber variable dispersion compensator in an OCT system has been shown to independently adjust the delay and the dispersion in the two arms of the interferometer.

The optical system of the present invention is made entirely of fiber elements and does not require any critical alignment. This makes the system advantageously compact and versatile for use in in vivo experimentation when applied to an OCT system. Additionally, the technique could similarly be used to compensate at least part of the sample dispersion in an OCT system.

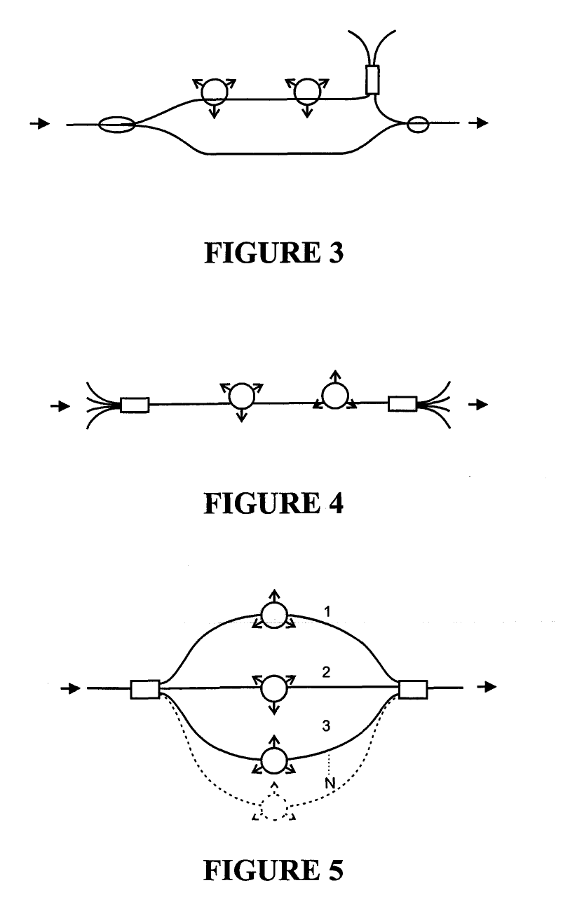

Use of the optical system of the present invention does not require the two stretchers to be placed in different arms of the interferometer. Instead, the stretchers can be placed in sequence in one particular arm. The operation of such a serial sequence of stretchers is entirely equivalent to that of parallel stretchers as long as the stretcher that was displaced from one arm to the other is operated in the reverse direction. That is, if both stretchers must be stretched in a parallel configuration to achieve a certain result, then one must be stretched and the other unstretched to provide the same outcome in the serial configuration. FIG. 3 illustrates an arrangement similar to that shown in FIG. 1 where two fiber stretchers are located in a single arm of a Mach-Zehnder interferometer.

In addition, the use of a serial sequence of stretchers is not restricted to interferometer geometries as it can be used to adjust the dispersion and the group delay of a single piece of fiber, for example, in telecommunication system applications such as WDM systems. FIG. 4 illustrates a general arrangement of two fiber stretchers that can be simultaneously stretched and unstretched to maintain group delay while providing a change in dispersion seen by propagating light.

Dispersion and optical path length compensation using the inventive concepts described herein can be freely operable or alternatively, operated once to calibrate a system before being fixed into position to prevent future movement. It is envisaged this invention could be used by manufacturers who wish to calibrate a system only once in a product that is to be sold.

It is further envisaged that the inventive scope is not restricted to stretching optical fibers. Instead, any other suitable types of waveguide that provides a dispersion change when stretched, or generally deformed, may be used in place of the optical fiber used in the foregoing examples.

It is further envisaged that more than two other waveguide stretchers can be used in parallel or serial arrangement. For example, three waveguide stretchers can be provided to compensate three parallel optical paths as long as each stretcher has different dispersion parameters. FIG. 5 illustrates an arrangement of three fiber stretching devices arranged in parallel. The parallel paths may further include two or more stretchers in one path, no stretcher in the second path, and a single stretcher in the third path. Other similar combinations and examples of stretchers arranged in optical paths will be evident to those skilled in the art in light of the foregoing.

In a further embodiment of the present invention the dual fibre stretchers are used in a Fourier OCT system. A Fourier OCT system requires no delay line to scan. Instead, the detector, which is normally a photodiode, is replaced with an optical spectrum analyser. Scanning of the signal depth is performed by Fourier-transforming the measured spectral output. In such an arrangement, scanning can be performed at high speeds by real time Fourier analysis.

1. An optical system, comprising:
an input adapted to couple light to at least two optical paths, a first optical path having a first waveguide, said first waveguide having a first dispersion parameter, a first optical path length and is deformable to change said first dispersion parameter and said first optical path length,
said second optical path having a second waveguide, said second waveguide having a second dispersion parameter, a second optical path length and is deformable to change said second dispersion parameter and said second optical path length,
an output adapted to receive light from said at least two optical paths
a first deforming device adapted to deform said first waveguide, and
a second deforming device adapted to deform said second waveguide,
wherein said first deforming device and said second deforming device are operable to adjust said dispersion of light in said first optical path and maintain said path length of said first optical path relative to said second optical path.

2. A system as claimed in claim 1, wherein said first optical path is a first arm of a Mach-Zehnder interferometer and said second optical path is a second arm of said Mach-Zehnder interferometer.

3. A system as claimed in claim 2, wherein said first arm has an interferometry output for coupling light from said first arm and an interferometry input for coupling light into said first arm.

4. A system as claimed in claim 3, wherein said light coupled out of said first arm by said interferometry output is reflected by a sample under test and coupled into said first arm by said interferometry input.

5. A system as claimed in claim 1, wherein said system is an Optical Coherence Tomography apparatus, said apparatus further comprising:
a broadband light source adapted to transmit to said input,
a detector adapted to receive light from said output, and
a delay line located in either said first or said second optical path.

6. A system as claimed in claim 1, wherein said system is Wavelength Division Multiplexing apparatus.

7. A system as claimed in claim 1, wherein said first waveguide and said second waveguide have unequal dispersion parameters.

8. A system as claimed in claim 1, wherein said dispersion parameter is a second order dispersion coefficient.

9. A system as claimed in claim 1, wherein at least said first waveguide or said second waveguide is an optical fiber.

10. A system as claimed in claim 9, wherein at least said first deforming device or said second deforming device is an optical fiber stretcher.

11. A system as claimed in claim 1, wherein said first waveguide has a first waveguide dispersion modifier coefficient, said second waveguide has a second waveguide dispersion modifier coefficient, and a ratio between said first and second dispersion parameters, multiplied by their respective strain induced waveguide dispersion modifier coefficients, are unequal.

12. A method of arranging an optical system, comprising the steps of:
adapting an light receiver to receive light from a light source and couple said input light to at least two optical paths,
arranging a first deformable waveguide in a first optical path, said first waveguide having a first dispersion parameter and a first optical path length, said first waveguide deformable to alter said first dispersion parameter and said first optical path length,
arranging a second deformable waveguide in a second optical path, said second waveguide having a second dispersion parameter and a second optical path length, said second waveguide deformable to alter said second dispersion parameter and said second optical path length,
deforming said first and said second waveguides adjust said first and second dispersion parameters and maintain said path length of said first optical path relative to said second optical path.

13. A method as claimed in claim 12, the method further comprising configuring said first optical path is to be a first arm of a Mach-Zehnder interferometer and configuring said second optical path to be a second arm of said Mach-Zehnder interferometer.

14. A method as claimed in claim 13, the method further comprising configuring an interferometry output in said first arm has for coupling light from said first interferometer arm and an interferometry input for coupling light into said first interferometer arm.

15. A method as claimed in claim 13, method further comprising transmitting light from said interferometry output to a sample under test, and receiving light reflected from said sample in said interferometry input.

16. A method as claimed in claim 1, wherein at least said first deforming device or said second deforming device is an optical fiber stretcher.

17. An optical system, comprising:
an optical path having at least at first and second waveguide,
a first waveguide having an input to receive light and an output to transmit light,
a second waveguide having an input to receive light and an output to transmit light, said input of said second waveguide configurable to receive light from said input of said first waveguide,
a first deforming device adapted to deform said first waveguide, and
a second deforming device adapted to deform said second waveguide,
wherein said first deforming device and said second deforming device are operable to adjust said dispersion of light in said optical path and said optical path length.

18. A system as claimed in claim 17, wherein said system is Wavelength Division Multiplexing apparatus.

19. A system as claimed in claim 17, wherein said first waveguide and said second waveguide have unequal dispersion parameters.

20. A system as claimed in claim 17, wherein said dispersion parameter is a second order dispersion coefficient.

21. A system as claimed in claim 17, wherein at least said first waveguide or said second waveguide is an optical fiber.

22. A system as claimed in claim 17, wherein at least said first deforming device or said second deforming device is an optical fiber stretcher.

23. A system as claimed in claim 17, wherein said first waveguide has a first waveguide dispersion modifier coefficient, said second waveguide has a second waveguide dispersion modifier coefficient, and a ratio between said first and second dispersion parameters, multiplied by a respective strain induced waveguide dispersion modifier coefficients, are unequal.

24. A method of arranging an optical system, comprising:
arranging at least a first and second waveguide in series to define an optical path, said first waveguide having an input to receive light and an output to transmit light, said second waveguide having an input to receive light and an output to transmit light.

25. A method as claimed in claim 24, the method further comprising deforming said first and said second waveguides to adjust said dispersion of said light in said optical path.

26. A method as claimed in claim 24, the method further comprising transmitting a broadband light source to the input of said optical path.
